(19) United States
(12) Patent Application Publication
(10) Pub. No.: US 2025/0084259 A1
(43) Pub. Date: Mar. 13, 2025

(54) EFFECT COATING COMPOSITION AND METHOD FOR FORMING MULTILAYER COATING FILM

(71) Applicant: KANSAI PAINT CO., LTD., Hyogo (JP)

(72) Inventors: Nobuhiko NARITA, Kanagawa (JP); Maiko Hayashi, Kanagawa (JP)

(73) Assignee: KANSAI PAINT CO., LTD., Hyogo (JP)

(21) Appl. No.: 18/828,234

(22) Filed: Sep. 9, 2024

(30) Foreign Application Priority Data
Sep. 13, 2023 (JP) 2023-148104

(51) Int. Cl. C09D 5/36; C09D 7/45; C09D 183/04; C23C 24/10

(52) U.S. Cl. CPC C09D 5/36; C09D 7/45; C09D 183/04; C23C 24/103

(57) ABSTRACT

An effect coating composition containing indium particles (A), a surface conditioner (B), a pigment dispersant (C), a viscosity modifier (D), and water (E). The effect coating composition has a solid content percentage of from 0.1 to 15 mass %.

### TECHNICAL FIELD

The present invention relates to an effect coating composition and a method for forming a multilayer coating film.

### BACKGROUND ART

The purpose of applying a coating material is primarily to protect a material and impart an aesthetic appearance. For industrial products, aesthetic appearance, especially “texture”, is important from the viewpoint of increasing the product appeal. Consumers have sought a diverse variety of textures for industrial products, and in recent years, a demand has arisen for excellent glossiness in fields such as automobile outer panels, automobile parts, and home electrical appliances.

Techniques for imparting excellent glossiness to the surfaces of industrial products include metal plating and metal vapor deposition processing (for example, see JP 63-272544 A). However, if excellent glossiness can be imparted by applying a coating material, such a technique is advantageous from viewpoints such as convenience and cost.

JP 2003-313500 A indicates that a good metallic appearance can be provided by a metallic coating material produced by diluting, at a dilution percentage of from 150 to 500%, a metallic coating material base agent containing an effect material, a resin-containing nonvolatile solid component, and a solvent with a diluent containing a high-boiling-point solvent and a low-boiling-point solvent, and then adding from 5 to 10 parts by weight of a viscous resin per 100 parts by weight of the resin content in the metallic coating material base agent.

However, the appearance formed by the metallic coating material does not exhibit satisfactory glossiness, and from perspectives such as reducing the environmental impact, a demand has arisen for forming the coating composition as a water-based coating composition.

Meanwhile, in recent years, attention has been focused on automatic driving as an important next-generation automotive technology. In order to enable automatic driving, various sensing technologies must be used, one of which is application of millimeter wave radar.

However, when a large amount of an effect pigment such as aluminum is blended in a coating composition to impart excellent glossiness, the formed coating film unfortunately blocks the millimeter wave radar.

### SUMMARY OF INVENTION

### Technical Problem

Thus, an object of the present invention is to provide an effect coating composition by which a coating film having excellent glossiness and high millimeter wave transmittance can be formed.

### Solution to Problem

The present invention encompasses the subject matter described in the following items.

Aspect 1. An effect coating composition containing indium particles (A), a surface conditioner (B), a pigment dispersant (C), a viscosity modifier (D), and water (E), the effect coating composition having a solid content percentage of from 0.1 to 15 mass %.

Aspect 2. The effect coating composition according to aspect 1, wherein the surface conditioner (B) includes a silicone-based surface conditioner.

Aspect 3. The effect coating composition according to aspect 1 or 2, wherein the pigment dispersant (C) includes a phosphate group-containing compound.

Aspect 4. The effect coating composition according to any one of aspects 1 to 3, wherein the viscosity modifier (D) includes an associative viscosity modifier.

Aspect 5. The effect coating composition according to any one of aspects 1 to 4, wherein the content of the water (E) is in a range from 50 to 95 parts by mass per 100 parts by mass of a total of all components of the effect coating composition.

Aspect 6. A method for forming a multilayer coating film, the method including:
(1): applying the effect coating composition described in any one of aspects 1 to 5 onto an object to be coated to form an effect coating film;
(2): applying a clear coating composition (Z) onto the effect coating film produced in (1) to form a clear coating film; and
(3): heating, separately or simultaneously, the effect coating film formed in (1) and the clear coating film formed in (2) to thereby cure the effect coating film and the clear coating film.

### Advantageous Effects of Invention

According to the effect coating composition of the present invention, a coating film having excellent glossiness and high millimeter wave transmittance can be formed.

### DESCRIPTION OF EMBODIMENTS

### Effect Coating Composition

An effect coating composition according to an embodiment of the present invention contains indium particles (A), a surface conditioner (B), a pigment dispersant (C), a viscosity modifier (D), and water (E), and has a solid content percentage of from 0.1 to 15 mass %.

### Indium Particle (A)

The indium particle (A) is a flaky particle. The flaky particle may be also referred to as a scale-like particle, a sheet-like particle, or a flake-like particle.

In an embodiment of the present invention, a flaky particle means a particle having a substantially flat surface and a thickness in a direction perpendicular to the substantially flat surface is substantially uniform. Furthermore, the flaky particle means a particle with a shape, in which the thickness is extremely thin and a length of the substantially flat surface is extremely long. Note that the length of the substantially flat surface is a diameter of a circle having a projected area that is the same as a projected area of the flaky particle.

The shape of the substantially flat surface is not particularly limited and can be selected appropriately based on the purpose. Examples of the shape include a polygon such as a substantially rectangular, substantially square, substantially circular, substantially elliptical, substantially triangular, substantially quadrilateral, substantially pentagonal, substantially hexagonal, substantially heptagonal, or substantially octagonal shape, and a random irregular shape. Among these, a substantially circular shape is preferred.

The indium particles (A) may form one layer or may form a primary particle with two or more layers layered thereon. Furthermore, primary particles of the indium particles (A) may aggregate to form a secondary particle.

Note that the indium particle (A) is made of indium with a purity of 95% or greater, and may contain a trace amount of impurities but does not contain an alloy with another metal.

The indium particle (A) can be produced by performing release layer formation, vacuum deposition, releasing, and, as necessary, another process.

### Release Layer Formation

Release layer formation is a process of providing a release layer on a substrate.

The substrate is not particularly limited as long as the substrate has a smooth surface, and various substrates can be used. Among these, a resin film, metal foil, or composite film of a metal foil and a resin film, having flexibility, heat resistance, solvent resistance, and dimensional stability can be suitably used. Examples of the resin film include a polyester film, a polyethylene film, a polypropylene film, a polystyrene film, and a polyimide film. Examples of the metal foil include copper foil, aluminum foil, nickel foil, iron foil, and alloy foil. Examples of the composite film of a metal foil and a resin film include a composite film produced by laminating the resin film and the metal foil described above.

As the release layer, various organic materials that can be dissolved in the releasing described below can be used. Furthermore, when the organic material constituting the release layer is appropriately selected, an organic material attached to and remaining on an attachment face of an island structure film can function as a protective layer of the indium particle (A), which is preferable.

The protective layer has a function of suppressing aggregation of the indium particle (A), oxidation of the indium particle (A), elution of the indium particle (A) into a solvent, and the like. In particular, using the organic material used for the release layer as a protective layer is preferred because surface treatment is not required to be additionally performed.

Examples of the organic material constituting the release layer that can be used as a protective layer include cellulose acetate butyrate (CAB) and other cellulose derivatives, polyvinyl alcohol, polyvinyl butyral, polyethylene glycol, polyacrylic acid, polyacrylamide, polyvinyl butyral, an acrylic acid copolymer, a modified nylon resin, polyvinylpyrrolidone, a urethane resin, a polyester resin, a polyether resin, and an alkyd resin. These may be used alone or in a combination of two or more types thereof. Among these, from the viewpoint of high functionality as a protective layer, cellulose acetate butyrate (CAB) is preferred.

The forming method of the release layer is not particularly limited and can be appropriately selected based on the purpose. Examples of the method include an inkjet method, a blade coating method, a gravure coating method, a gravure offset coating method, a bar coating method, a roll coating method, a knife coating method, an air knife coating method, a comma coating method, a U comma coating method, an AKKU coating method, a smoothing coating method, a micro-gravure coating method, a reverse roll coating method, a four-roll coating method, a five-roll coating method, a dip coating method, a curtain coating method, a slide coating method, and a die coating method. These may be used alone or in a combination of two or more types thereof.

### Vacuum Deposition

The vacuum deposition is a process of performing vacuum deposition of a metal layer containing indium particles (A) onto the release layer.

The average vapor deposition thickness of the metal layer containing the indium particles (A) is preferably 60 nm or less, more preferably 55 nm or less, even more preferably 50 nm or less, and particularly preferably 45 nm or less. Note that the average vapor deposition thickness of the metal layer containing the indium particles (A) is the same as the average thickness of the indium particle (A).

When the average vapor deposition thickness of the metal layer is 60 nm or less, a surface roughness Ra of the coating film decreases, and excellent glossiness can be exhibited, which is advantageous. The average vapor deposition thickness is determined by, for example, observing a cross-section of a metal layer, measuring thicknesses at 5 to 10 positions of the metal layer by using a scanning electron microscope (SEM), and averaging the measured thicknesses.

The metal layer is preferably an island structure film. The island structure film can be formed by various methods such as a vacuum deposition method, a sputtering method, and a plating method. Among these, a vacuum deposition method is preferred.

The vacuum deposition method is more preferred than the plating method from the viewpoints of being capable of forming a film on a resin substrate, generating no waste fluid, and the like, and is more preferred than the sputtering method from the viewpoints of being capable of setting a degree of vacuum high and achieving a high film formation rate (vapor deposition rate) and the like.

The vapor deposition rate in the vacuum deposition method is preferably 10 nm/sec or faster, and more preferably 10 nm/sec or faster and 80 nm/sec or slower.

### Releasing

The releasing is a process of releasing the metal layer by dissolving the release layer. The solvent that can dissolve the release layer is not particularly limited as long as the solvent is a solvent that can dissolve the release layer, and can be appropriately selected based on the purpose; however, the solvent is preferably a solvent that can be used as is as a solvent for the effect coating composition (A).

Examples of the solvent that can dissolve the release layer include an alcohol-based solvent such as methanol, ethanol, propanol, isopropanol, butanol, octanol, dodecanol, ethylene glycol, and propylene glycol; an ether-based solvent such as tetrahydron; a ketone-based solvent such as acetone, methyl ethyl ketone, and acetylacetone; an ester-based solvent such as methyl acetate, ethyl acetate, butyl acetate, and phenyl acetate; a glycol ether-based solvent such as ethyl cellosolve, butyl cellosolve, ethyl carbitol, butyl carbitol, ethylene glycol monomethyl ether, ethylene glycol monoethyl ether, ethylene glycol monoisopropyl ether, ethylene glycol monobutyl ether, ethylene glycol monohexyl ether, ethylene glycol monophenyl ether, diethylene glycol monomethyl ether, diethylene glycol monoethyl ether, diethylene glycol monobutyl ether, diethylene glycol dimethyl ether, diethylene glycol diethyl ether, triethylene glycol monomethyl ether, triethylene glycol monoethyl ether, triethylene glycol monobutyl ether, propylene glycol monomethyl ether, propylene glycol monoethyl ether, dipropylene glycol monomethyl ether, dipropylene glycol monoethyl ether, and diethylene glycol monomethyl ether acetate; a phenol-based solvent such as phenol and cresol; an aliphatic or aromatic hydrocarbon-based solvent such as pentane, hexane, heptane, octane, dodecane, tridecane, tetradecane, pentadecane, hexadecane, octadecane, octadecene, benzene, toluene, xylene, trimethine, nitrobenzene, aniline, methoxybenzene, and trimethine; an aliphatic or aromatic chlorinated hydrocarbon-based solvent such as dichloromethane, chloroform, trichloroethane, chlorobenzene, and dichlorobenzene; a sulfur-containing compound-based solvent such as dimethyl sulfoxide; and a nitrogen-containing compound-based solvent such as dimethylformamide, dimethylacetamide, acetonitrile, propionitrile, and benzonitrile. These may be used alone or in a combination of two or more types thereof.

By dissolving the release layer, the island structure film is released from the substrate, and then the island structure breaks up, and each island becomes an indium particle (A). As a result, an indium particle (A) dispersion liquid is produced without particularly implementing crushing; however, as necessary, crushing and classification may be performed. Furthermore, in a case in which primary particles of indium particles (A) are aggregated, as necessary, such an aggregate may be crushed.

Furthermore, as necessary, various treatments may be implemented to recover the indium particles (A) and to adjust the physical properties of the indium particles (A). For example, the particle size of the indium particle (A) may be adjusted by classification, the indium particles (A) may be recovered by a method such as centrifugal separation or suction filtration, and the solid concentration of the dispersion liquid may be adjusted. In addition, solvent substitution may be performed, and viscosity adjustment and the like may be performed by using an additive.

### Other Processes

Examples of other processes include a process of taking out the released metal layer as a dispersion liquid, a process of recovering the island-like metal layer as the indium particles (A) from the dispersion liquid, and the like.

From the viewpoint of forming a multilayer coating film having excellent glossiness, a 50% cumulative volumetric average particle size D50 of the indium particles (A) produced by performing the release layer formation, the vacuum deposition, the releasing, and optional other processes is preferably 0.70 m or less, more preferably 0.60 m or less, even more preferably 0.50 m or less, and particularly preferably 0.40 m or less.

The indium particles (A) may be a commercially available product. Examples of the commercially available product include “LeafPowder 49CJ-1120”, “LeafPowder 49CJ-1150”, “LeafPowder 49BJ-1120”, and “LeafPowder 49BJ-1150” (available from Oike & Co., Ltd.).

From the viewpoint of forming a coating film having excellent glossiness and high millimeter wave transmittance, the effect coating composition of the present invention contains the indium particles (A) at an amount of preferably 50 parts by mass or greater, more preferably 55 parts by mass or greater, even more preferably in a range from 60 to 95 parts by mass, and particularly preferably in a range from 65 to 90 parts by mass, per 100 parts by mass of the solid content of the effect coating composition.

### Surface Conditioner (B)

Examples of the surface conditioner (B) include a silicone-based surface conditioner, an acrylic-based surface conditioner, a vinyl-based surface conditioner, a fluorine-based surface conditioner, and an acetylene diol-based surface conditioner. Among these, from the viewpoint of producing a coating film having excellent glossiness, the effect coating composition preferably contains a silicone-based surface conditioner. The surface conditioners can be used alone or in appropriate combination of two or more.

As the silicone-based surface conditioner, polydimethylsiloxane or a modified silicone in which polydimethylsiloxane is modified may be used. Examples of the modified silicone include polyether-modified silicone, acrylic-modified silicone, and polyester-modified silicone.

From the viewpoints of forming a coating film having excellent glossiness and high millimeter wave transmittance, the content of the surface conditioner (B) in the effect coating composition of the present invention is preferably from 0.5 to 20 part by mass, more preferably from 1 to 15 parts by mass, and even more preferably from 3 to 10 parts by mass, per 100 parts by mass of the solid content of the effect coating composition.

### Pigment Dispersant (C)

As the pigment dispersant (C), for example, any anionic, cationic, or nonionic compound can be used, and among these, an anionic compound is preferably used from the viewpoint of forming a coating film having excellent glossiness and high millimeter wave transmittance. A single type of the pigment dispersant (C) may be used alone, or two or more types may be mixed and used.

As the anionic compound, a compound having a functional group such as a phosphoric acid group, a carboxyl group, a sulfonic acid group, or a sulfate group can be used, and among these, a compound having a phosphoric acid group, that is, a phosphoric acid group-containing compound is preferably included from the viewpoint of forming a coating film having excellent glossiness.

The anionic compound may be neutralized with a neutralizing agent before use. Examples of the neutralizing agent include ammonia; primary monoamines such as ethylamine, propylamine, butylamine, benzylamine, monoethanolamine, neopentanolamine, 2-aminopropanol, 2-amino-2-methyl-1-propanol, and 3-aminopropanol; secondary monoamines such as diethylamine, diethanolamine, di-n- or di-iso-propanolamine, N-methylethanolamine, and N-ethylethanolamine; tertiary monoamines such as trimethylamine, triethylamine, triisopropylamine, methyldiethanolamine, and dimethylethanolamine; and polyamines such as diethylenetriamine, hydroxyethylaminoethylamine, ethylaminoethylamine, and methylaminopropylamine.

Examples of the phosphate group-containing compound include polyoxyethylene alkyl ether phosphoric acid salts, polyoxyethylene phenyl ether phosphoric acids, alkyl phosphate esters, and alkyl phosphate ester salts.

From the viewpoints of forming a coating film having excellent glossiness and high millimeter wave transmittance, the content of the pigment dispersant (C) in the effect coating composition of the present invention is preferably from 0.5 to 20 part by mass, more preferably from 1 to 15 parts by mass, and even more preferably from 3 to 10 parts by mass, per 100 parts by mass of the solid content of the effect coating composition.

### Viscosity Modifier (D)

Examples of the viscosity modifier (D) include associative viscosity modifiers, inorganic viscosity modifiers, polyacrylic acid-based viscosity modifiers, cellulose derivative-based viscosity modifiers, protein-based viscosity modifiers, alginic acid-based viscosity modifiers, polyvinyl-based viscosity modifiers, polyether-based viscosity modifiers, maleic anhydride copolymer-based viscosity modifiers, and polyamide-based viscosity modifiers. Among these, from the viewpoint of producing a coating film having excellent glossiness, use of an associative viscosity modifier is preferable, and use of an acrylic associative viscosity modifier described below is particularly preferable.

Examples of the associative viscosity modifier include an acrylic associative viscosity modifier that is an acrylic resin having a hydrophilic acrylic main chain and a hydrophobic side chain; and a urethane associative viscosity modifier that has a hydrophobic moiety, a urethane bond, and a polyether chain in one molecule and effectively exhibits a thickening action by associating the hydrophobic moieties in an aqueous medium.

Examples of the inorganic viscosity modifier include silicates, metal silicates, montmorillonite, organic montmorillonite, and colloidal alumina.

Examples of the polyacrylic acid-based viscosity modifier include sodium polyacrylate and polyacrylic acid-(meth)acrylate copolymers.

Examples of the cellulose derivative-based viscosity modifier include carboxymethyl cellulose, methyl cellulose, hydroxyethyl cellulose, and cellulose nanofibers.

Examples of the protein-based viscosity modifier include casein, sodium caseinate, and ammonium caseinate.

Examples of the alginic acid-based viscosity modifier include sodium alginate.

Examples of the polyvinyl-based viscosity modifier include polyvinyl alcohol, polyvinyl pyrrolidone, and polyvinyl benzyl ether copolymer.

Examples of the polyether-based viscosity modifier include polyether dialkyl esters, polyether dialkyl ethers, and polyether epoxy-modified products.

Examples of the maleic anhydride copolymer-based viscosity modifier include a partial ester of a vinyl methyl ether-maleic anhydride copolymer.

Examples of the polyamide-based viscosity modifier include polyamidoamine salts.

These viscosity modifiers (D) can each be used alone or in combination of two or more.

From the viewpoints of forming a coating film having excellent glossiness and high millimeter wave transmittance, the content of the viscosity modifier (D) in the effect coating composition of the present invention is preferably from 0.5 to 20 part by mass, more preferably from 1 to 15 parts by mass, and even more preferably from 3 to 10 parts by mass, per 100 parts by mass of the solid content of the effect coating composition.

### Water (E)

From the viewpoint of forming a coating film having excellent glossiness and high millimeter wave transmittance, the content of the water (E) in the effect coating composition of the present invention is preferably in a range from 45 to 95 parts by mass, more preferably in a range from 55 to 93 parts by mass, and even more preferably in a range from 65 to 90 parts by mass, per 100 parts by mass of the total of all components of the effect coating composition.

In addition, from the viewpoint of forming a coating film having excellent glossiness and high millimeter wave transmittance, the content ratio of the solid content of the effect coating composition is preferably in a range from 0.5 to 10 mass % and more preferably in a range from 1.5 to 6 mass %.

In the present specification, the “solid content” means a nonvolatile component such as a resin, a curing agent, or a pigment contained in the coating composition, which remains after the coating composition is dried at 110° C. for 1 hour. Thus, for example, the total solid content of the coating composition can be calculated by weighing the coating composition in a heat-resistant container such as an aluminum foil cup, spreading the coating composition on the bottom of the container, then drying the coating composition at 110° C. for 1 hour, weighing the mass of components in the coating composition remaining after drying, and determining a ratio of the mass of the components remaining after drying to the total mass of the coating composition before drying.

### Other Components

As necessary, the effect coating composition may further appropriately contain an organic solvent, a pigment other than the indium particles (A), a binder resin, a cross-linking component, an ultraviolet absorber, a light stabilizer, and the like.

An organic solvent commonly used in coating materials can be used as the organic solvent. Specific examples thereof include an alcohol-based solvent such as methanol, ethanol, propanol, isopropanol, butanol, octanol, dodecanol, ethylene glycol, and propylene glycol; an ether-based solvent such as tetrahydron; a ketone-based solvent such as acetone, methyl ethyl ketone, and acetylacetone; an ester-based solvent such as methyl acetate, ethyl acetate, butyl acetate, and phenyl acetate; a glycol ether-based solvent such as ethyl cellosolve, butyl cellosolve, ethyl carbitol, butyl carbitol, ethylene glycol monomethyl ether, ethylene glycol monoethyl ether, ethylene glycol monoisopropyl ether, ethylene glycol monobutyl ether, ethylene glycol monohexyl ether, ethylene glycol monophenyl ether, diethylene glycol monomethyl ether, diethylene glycol monoethyl ether, diethylene glycol monobutyl ether, diethylene glycol dimethyl ether, diethylene glycol diethyl ether, triethylene glycol monomethyl ether, triethylene glycol monoethyl ether, triethylene glycol monobutyl ether, propylene glycol monomethyl ether, propylene glycol monoethyl ether, dipropylene glycol monomethyl ether, dipropylene glycol monoethyl ether, and diethylene glycol monomethyl ether acetate; a phenol-based solvent such as phenol and cresol; an aliphatic or aromatic hydrocarbon-based solvent such as pentane, hexane, heptane, octane, dodecane, tridecane, tetradecane, pentadecane, hexadecane, octadecane, octadecene, benzene, toluene, xylene, trimethine, nitrobenzene, aniline, methoxybenzene, and trimethine; an aliphatic or aromatic chlorinated hydrocarbon-based solvent such as dichloromethane, chloroform, trichloroethane, chlorobenzene, and dichlorobenzene; a sulfur-containing compound-based solvent such as dimethyl sulfoxide; and a nitrogen-containing compound-based solvent such as dimethylformamide, dimethylacetamide, acetonitrile, propionitrile, and benzonitrile. These may be used alone or in a combination of two or more types thereof.

Examples of the pigment other than the indium particles (A) include a coloring pigment, an effect pigment other than the indium particles (A), and an extender pigment. The pigments other than the indium particles (A) may be used alone or in a combination of two or more types. Examples of the coloring pigment include titanium oxide, zinc oxide, carbon black, molybdenum red, Prussian blue, cobalt blue, azo-based pigments, phthalocyanine-based pigments, quinacridone-based pigments, isoindoline-based pigments, threne-based pigments, perylene-based pigments, dioxazine-based pigments, and diketopyrrolopyrrole-based pigments. Examples of the effect pigment other than the indium particles (A) include a vapor-deposited metal flake pigment other than the indium particles (A), an aluminum flake pigment, and a light interference pigment. Examples of the extender pigment include clay, kaolin, barium sulfate, barium carbonate, calcium carbonate, talc, silica, and alumina white.

In a case in which the effect coating composition of the present invention contains a pigment other than the indium particles (A), from the viewpoint of forming a coating film having excellent glossiness and high millimeter wave transmittance, the content of the pigment other than the indium particles (A) is preferably in a range from 0.01 to 10 parts by mass, more preferably in a range from 0.05 to 8 parts by mass, and even more preferably in a range from 0.1 to 5 parts by mass, per 100 parts by mass of the solid content of the effect coating composition.

Examples of the binder resin include resins such as an acrylic resin, a polyester resin, a polyether resin, a polycarbonate resin, a polyurethane resin, an epoxy resin, and an alkyd resin, and among these, an acrylic resin is preferably contained, a water-soluble or water-dispersible acrylic resin is more preferably contained, and a water-soluble acrylic resin is even more preferably contained. These resins may be used alone, or in a combination of two or more types.

In a case in which the effect coating composition of the present invention contains a binder resin, from the viewpoint of forming a coating film having excellent glossiness and high millimeter wave transmittance, the content of the binder resin is preferably in a range from 0.01 to 10 parts by mass, more preferably in a range from 0.05 to 8 parts by mass, and even more preferably in a range from 0.1 to 5 parts by mass, per 100 parts by mass of the solid content of the effect coating composition.

Examples of the cross-linking component include a melamine resin, a melamine resin derivative, a urea resin, (meth)acrylamide, polyaziridine, polycarbodiimide, and a blocked or unblocked polyisocyanate compound.

In a case in which the effect coating composition of the present invention contains a cross-linking component, from the viewpoint of forming a coating film having excellent glossiness and high millimeter wave transmittance, the content of the cross-linking component is preferably in a range from 0.01 to 10 parts by mass, more preferably in a range from 0.05 to 8 parts by mass, and even more preferably in a range from 0.1 to 5 parts by mass, per 100 parts by mass of the solid content of the effect coating composition.

### Method for Forming Multilayer Coating Film

A method for forming a multilayer coating film according to the present invention includes:
(1): applying the effect coating composition of the present disclosure onto an object to be coated to form an effect coating film;
(2): applying a clear coating composition (Z) onto the effect coating film produced in (1) to form a clear coating film; and
(3): heating, separately or simultaneously, the effect coating film formed in (1) and the clear coating film formed in (2) to thereby cure the effect coating film and the clear coating film.

### Step (1)

According to the multilayer coating film forming method of an embodiment of the present invention, first, an effect coating composition of an embodiment of the present invention is applied on an object to be coated, and an effect coating film is formed.

### Object to be Coated

The object to be coated to which the effect coating composition is applied is not particularly limited. Examples of the object to be coated include outer panel parts of automobile bodies, such as those of passenger cars, trucks, motorcycles, and buses; automobile parts such as bumpers; outer panel parts of home electrical appliances, such as mobile phones and audio devices. In particular, outer panel parts of automobile bodies and automobile parts are preferred. The term object to be coated may be used interchangeably with the term target object.

Materials of these objects to be coated are not particularly limited. Examples include metal materials, such as iron, aluminum, brass, copper, tin plates, stainless steel, galvanized steel, and zinc alloy (such as Zn—Al, Zn—Ni, and Zn—Fe)-plated steel; resins, such as polyethylene resins, polypropylene resins, acrylonitrile-butadiene-styrene (ABS) resins, polyamide resins, acrylic resins, vinylidene chloride resins, polycarbonate resins, polyurethane resins, and epoxy resins; plastic materials, such as various FRPs; inorganic materials, such as glass, cement, and concrete; woods; and fiber materials, such as paper and cloth. In particular, a metal material and a plastic material are preferred.

A surface of the object to be coated to which the multilayer coating film is applied may be a metal surface of, for example, outer panel parts of automobile bodies, automobile parts, home electronics, metal substrates such as steel sheets and the like constituting the foregoing, the metal surface thereof having been subjected to a surface treatment, such as a phosphate salt treatment, a chromate treatment, or a composite oxide treatment.

A coating film may be further formed on an object to be coated that may or may not be surface-treated. For example, an object to be coated, which is a substrate, may be surface-treated as necessary, and an undercoating film and/or an intermediate coating film may be formed on the treated surface. For example, when the object to be coated is an automobile body, the undercoating film and/or the intermediate coating film can be formed using coating compositions for undercoating and/or intermediate coating that are per se known and typically used in coating automobile bodies.

For example, an electrodeposition coating material, preferably a cationic electrodeposition coating material, can be used as the undercoating composition to form the undercoating film. In addition, a coating material that can be used as the intermediate coating composition for forming the intermediate coating film includes a coating material prepared using a base resin having a cross-linking functional group such as a carboxyl group or a hydroxyl group (for example, an acrylic resin, a polyester resin, an alkyd resin, a urethane resin, and an epoxy resin); and a crosslinking agent, such as an amino resin (for example, a melamine resin and a urea resin), or a polyisocyanate compound that may be blocked; together with a pigment, a thickener, and an optional additional component.

### Application of Effect Coating Composition

The effect coating composition can be applied according to a common method, such as air spray coating, airless spray coating, and rotary atomization coating. When the effect coating composition is applied, static electricity may be applied as necessary, and among methods for doing so, electrostatic coating by rotary atomization and electrostatic coating by air spraying are preferred, and electrostatic coating by rotary atomization is particularly preferred.

In a case in which the effect coating composition is applied by air spray coating, airless spray coating, or rotary atomization coating, the effect coating composition preferably contains, as appropriate, water and/or an organic solvent as well as an additive, such as a defoamer, as necessary, to adjust the viscosity to a level that is suitable for coating.

Furthermore, from the viewpoint of forming a multilayer coating film having excellent glossiness and high millimeter wave transmittance, the viscosity of the effect coating composition at 20° C. is approximately in a range from preferably 8 to 30 seconds, and particularly preferably from 10 to 25 seconds, as determined using a Ford viscosity cup No. 3 as a viscometer.

In addition, before application of the effect coating composition, the effect coating composition is preferably subjected to an ultrasonic dispersion treatment from the viewpoint of forming a coating film having excellent glossiness and high millimeter wave transmittance. As the disperser, for example, the “UH-50” (trade name, available from MST KK) can be used.

Furthermore, from the viewpoint of forming a coating film having excellent glossiness and high millimeter wave transmittance, the approximate cured film thickness of the effect coating film is preferably from 0.01 to 2 m, more preferably from 0.025 to 1 m, and even more preferably from 0.05 to 0.5 m.

### Step (2)

According to the multilayer coating film forming method of an embodiment of the present invention, subsequently, a clear coating composition (Z) is applied on the effect coating film produced in (1) to thereby form a clear coating film.

Examples of the clear coating composition (Z) that can be used include any known thermosetting coating compositions. Examples of the thermosetting coating composition include: organic solvent-type thermosetting coating compositions containing a crosslinkable functional group-containing base resin and a curing agent; aqueous thermosetting coating compositions; and powder thermosetting coating compositions.

Examples of the crosslinkable functional group contained in the base resin include a carboxyl group, a hydroxyl group, an epoxy group, and a silanol group. Examples of the type of base resin include acrylic resins, polyester resins, alkyd resins, urethane resins, epoxy resins, and fluororesins. Examples of the curing agent include polyisocyanate compounds, blocked polyisocyanate compounds, melamine resins, urea resins, carboxyl group-containing compounds, carboxyl group-containing resins, epoxy group-containing resins, and epoxy group-containing compounds.

The combination of the base resin/curing agent in the clear coating composition (Z) is preferably a carboxyl group-containing resin/epoxy group-containing resin, a hydroxyl group-containing resin/polyisocyanate compound, a hydroxyl group-containing resin/blocked polyisocyanate compound, a hydroxyl group-containing resin/melamine resin, or the like.

In addition, the clear coating composition (Z) may be a one-component coating material or a multi-component coating material, such as a two-component coating material. The two-component type coating material may be a coating material composed of a liquid containing a base resin and another liquid containing a curing agent.

Among these, from the viewpoint of adherence of the resulting coating film, the clear coating composition (Z) is preferably a two-component clear coating material containing a hydroxyl group-containing resin (z1) and a polyisocyanate compound (z2), which are described below.

### Hydroxyl Group-Containing Resin (z1)

The hydroxyl group-containing resin (z1) is a resin having at least one hydroxyl group per molecule. Examples of the hydroxyl group-containing resin (z1) include resins having a hydroxyl group, such as acrylic resins, polyester resins, polyurethane resins, polyolefin resins, polyether resins, polycarbonate resins, epoxy resins, and alkyd resins. These resins may be used alone, or in a combination of two or more types.

From the viewpoint of adherence of the resulting multilayer coating film and the like, as the hydroxyl group-containing resin (z1), a hydroxyl group-containing acrylic resin (z11) is preferably used.

### Hydroxyl Group-Containing Acrylic Resin (z11)

The hydroxyl group-containing acrylic resin (z11) can be produced, for example, by copolymerizing a polymerizable unsaturated monomer that can be copolymerized with a hydroxyl group-containing polymerizable unsaturated monomer and the hydroxyl group-containing polymerizable unsaturated monomer by a method known per se, such as a solution polymerization method in an organic solvent or an emulsion polymerization method in water.

The hydroxyl group-containing polymerizable unsaturated monomer is a compound having one or more hydroxyl groups and one or more polymerizable unsaturated bonds per molecule. Examples of the hydroxyl group-containing polymerizable unsaturated monomer include monoesterified products of a (meth)acrylic acid and a dihydric alcohol having from 2 to 8 carbons, such as 2-hydroxyethyl (meth)acrylate, 2-hydroxypropyl (meth)acrylate, 3-hydroxypropyl (meth)acrylate, and 4-hydroxybutyl (meth)acrylate; F-caprolactone modified products of these monoesterified products of a (meth)acrylic acid and a dihydric alcohol having from 2 to 8 carbons; N-hydroxymethyl (meth)acrylamide; allyl alcohols; and (meth)acrylates having a polyoxyethylene chain with a hydroxyl group at the molecular terminal. However, in an embodiment of the present invention, the monomer corresponding to (xvii) a polymerizable unsaturated monomer having a UV absorbing functional group described below should be defined to be a polymerizable unsaturated monomer that can be copolymerized with the hydroxyl group-containing polymerizable unsaturated monomer and is excluded from the hydroxyl group-containing polymerizable unsaturated monomer. The hydroxyl group-containing polymerizable unsaturated monomers can be used alone or in combination of two or more.

As the polymerizable unsaturated monomer that can be copolymerized with the hydroxyl group-containing polymerizable unsaturated monomer, for example, monomers described in the following (i) to (xx) can be used. These polymerizable unsaturated monomers can be each used alone or in combination in two or more.
(i) Alkyl or cycloalkyl (meth)acrylates: for example, methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-hexyl (meth)acrylate, n-octyl (meth)acrylate, 2-ethylhexyl (meth)acrylate, nonyl (meth)acrylate, tridecyl (meth)acrylate, lauryl (meth)acrylate, stearyl (meth)acrylate, isostearyl (meth)acrylate, cyclohexyl (meth)acrylate, methylcyclohexyl (meth)acrylate, t-butylcyclohexyl (meth)acrylate, cyclododecyl (meth)acrylate, and tricyclodecanyl (meth)acrylate.
(ii) Polymerizable unsaturated monomers having an isobornyl group: such as isobornyl (meth)acrylate.
(iii) Polymerizable unsaturated monomers having an adamantyl group: for example, adamantyl (meth)acrylate.
(iv) Polymerizable unsaturated monomers having a tricyclodecenyl group: for example, tricyclodecenyl (meth)acrylate.
(v) Aromatic ring-containing polymerizable unsaturated monomers: for example, benzyl (meth)acrylate, styrene, α-methylstyrene, and vinyl toluene.
(vi) Polymerizable unsaturated monomers having an alkoxysilyl group: for example, vinyltrimethoxysilane, vinyltriethoxysilane, vinyltris(2-methoxyethoxy)silane, γ-(meth)acryloyloxypropyltrimethoxysilane, and γ-(meth)acryloyloxypropyltriethoxysilane.
(vii) Polymerizable unsaturated monomers having a fluorinated alkyl group: for example, perfluoroalkyl (meth)acrylates such as perfluorobutylethyl (meth)acrylate and perfluorooctylethyl (meth)acrylate; and fluoroolefins.
(viii) Polymerizable unsaturated monomers having a photopolymerizable functional group: for example, a maleimide group.
(ix) Vinyl compounds: for example, N-vinylpyrrolidone, ethylene, butadiene, chloroprene, vinyl propionate, and vinyl acetate.
(x) Carboxyl group-containing polymerizable unsaturated monomers: for example, (meth)acrylic acid, maleic acid, crotonic acid, and β-carboxyethyl (meth)acrylate.
(xi) Nitrogen-containing polymerizable unsaturated monomers: for example, (meth)acrylonitrile, (meth)acrylamide, N,N-dimethylaminoethyl (meth)acrylate, N,N-diethylaminoethyl (meth)acrylate, N,N-dimethylaminopropyl (meth)acrylamide, methylene bis(meth)acrylamide, ethylene bis(meth)acrylamide, and adducts of glycidyl (meth)acrylate and amine compounds.
(xii) Polymerizable unsaturated monomers having two or more polymerizable unsaturated groups per molecule: for example, allyl (meth)acrylate, ethylene glycol di(meth)acrylate, 1,4-butanediol di(meth)acrylate, neopentyl glycol di(meth)acrylate, and 1,6-hexanediol di(meth)acrylate.
(xiii) Epoxy group-containing polymerizable unsaturated monomers: for example, glycidyl (meth)acrylate, β-methylglycidyl (meth)acrylate, 3,4-epoxycyclohexyl methyl(meth)acrylate, 3,4-epoxycyclohexyl ethyl(meth)acrylate, 3,4-epoxycyclohexylpropyl (meth)acrylate, and allyl glycidyl ether.
(xiv) (Meth)acrylates having a polyoxyethylene chain with an alkoxy group at the molecular terminal.
(xv) Polymerizable unsaturated monomers having a sulfonic acid group: for example, 2-acrylamido-2-methylpropane sulfonic acid, 2-sulfoethyl (meth)acrylate, allyl sulfonic acid, 4-styrene sulfonic acid, and sodium salts and ammonium salts of these sulfonic acids.
(xvi) Polymerizable unsaturated monomers having a phosphate group: for example, acid phosphoxyethyl (meth)acrylate, acid phosphoxypropyl (meth)acrylate, acid phosphoxypoly(oxyethylene)glycol (meth)acrylate, and acid phosphoxypoly(oxypropylene)glycol (meth)acrylate.
(xvii) Polymerizable unsaturated monomers having a UV-absorbing functional group: for example, 2-hydroxy-4(3-methacryloyloxy-2-hydroxypropoxy)benzophenone, 2-hydroxy-4-(3-acryloyloxy-2-hydroxypropoxy)benzophenone, 2,2′-dihydroxy-4-(3-methacryloyloxy-2-hydroxypropoxy) benzophenone, 2,2′-dihydroxy-4-(3-acryloyloxy-2-hydroxypropoxy)benzophenone, and 2-[2-hydroxy-5-[2-(methacryloyloxy)ethyl]phenyl]-2H-benzotriazole.
(xviii) Photostable polymerizable unsaturated monomers: for example, 4-(meth)acryloyloxy-1,2,2,6,6-pentamethylpiperidine, 4-(meth)acryloyloxy-2,2,6,6-tetramethylpiperidine, 4-cyano-4-(meth)acryloylamino-2,2,6,6-tetramethylpiperidine, 1-(meth)acryloyl-4-(meth)acryloylamino-2,2,6,6-tetramethylpiperidine, 1-(meth)acryloyl-4-cyano-4-(meth)acryloylamino-2,2,6,6-tetramethylpiperidine, 4-crotonoyloxy-2,2,6,6-tetramethylpiperidine, 4-crotonoylamino-2,2,6,6-tetramethylpiperidine, and 1-crotonoyl-4-crotonoyloxy-2,2,6,6-tetramethylpiperidine.
(xix) Polymerizable unsaturated monomers having a carbonyl group: for example, acrolein, diacetone acrylamide, diacetone methacrylamide, acetoacetoxy ethyl methacrylate, formylstyrol, and vinyl alkyl ketones having from 4 to 7 carbons (for example, vinyl methyl ketone, vinyl ethyl ketone, and vinyl butyl ketone).
(xx) Polymerizable unsaturated monomers having an acid anhydride group: for example, maleic anhydride, itaconic anhydride, and citraconic anhydride.

In the present specification, a polymerizable unsaturated group means an unsaturated group that is radically polymerizable. Examples of such polymerizable unsaturated groups include a vinyl group and a (meth)acryloyl group.

In addition, in the present specification, “(meth)acrylate” means an acrylate or a methacrylate. “(Meth)acrylic acid” means acrylic acid or methacrylic acid. In addition, “(meth)acryloyl” means acryloyl or methacryloyl. Furthermore, “(meth)acrylamide” means acrylamide or methacrylamide.

From the viewpoints of adherence, chipping resistance, finished appearance, and the like of the multilayer coating film that is formed, the usage amount of the hydroxyl group-containing polymerizable unsaturated monomer in the production of the hydroxyl group-containing acrylic resin (z11) is favorably in a range from 15 to 50 mass %, and preferably in a rage from 20 to 40 mass %, with respect to the total amount of the polymerizable unsaturated monomer component constituting the hydroxyl group-containing acrylic resin (z11).

From the viewpoints of adherence, chipping resistance, finished appearance, and the like of the resulting multilayer coating film, the hydroxyl value of the hydroxyl group-containing acrylic resin (z11) is preferably in a range from 50 to 210 mg KOH/g, more preferably in a range from 80 to 200 mg KOH/g, and even more preferably in a range from 100 to 170 mg KOH/g.

From the viewpoints of adherence, chipping resistance, finished appearance, and the like of the resulting multilayer coating film, the weight average molecular weight of the hydroxyl group-containing acrylic resin (z11) is preferably in a range from 2000 to 50000, more preferably in a range from 3000 to 30000, and even more preferably in a range from 4000 to 10000.

From the viewpoints of finished appearance and adherence of the resulting multilayer coating film, the pot life of the clear coating composition (Z), and the like, the acid value of the hydroxyl group-containing acrylic resin (z11) is preferably 30 mg KOH/g or less, and particularly preferably in a range from 1 to 20 mg KOH/g.

In addition, from the viewpoints of adherence, chipping resistance, finished appearance, and the like of the multilayer coating film that is formed, the hydroxyl group-containing acrylic resin (z11) has a glass transition temperature in a range of preferably from −50 to 60° C., particularly preferably from 10 to 50° C., and more particularly preferably from 20 to 45° C.

In the present specification, the glass transition temperature (° C.) of the acrylic resin was calculated by the following equations.

$$1 / Tg ( K ) = ( W 1 / T 1 ) + ( W 2 / T 2 ) + … \qquad ( 1 )$$

$$Tg ( ° C . ) = Tg ( K ) - 273 \qquad ( 2 )$$

In the equations, W1, W2, and so on are the mass fractions of the monomers used for copolymerization, and T1, T2, and so on are the Tg (K) of the homopolymers of the monomers.

Note that, T1, T2, and so on are values according to Polymer Handbook (Second Edition, J. Brandup, E. H. Immergut, ed.) III, pp. 139-179. The glass transition temperature (° C.) used for cases where the Tg of the homopolymer of a monomer was unknown is assumed to be the static glass transition temperature, which is provided as follows. A sample is placed into a measuring cup of a differential scanning calorimeter “DSC-220U” (available from Seiko Instruments, Inc.), and vacuum suction is performed to completely remove the solvent; then, the change in heat quantity is measured in a range from −20° C. to +200° C. at a temperature increase rate of 3° C./min, and the change point of the initial baseline at the low-temperature end is recorded as the static glass transition temperature.

As a copolymerization method for producing the hydroxyl group-containing acrylic resin (z11) by copolymerizing the polymerizable unsaturated monomer mixture, it is possible to suitably use a solution polymerization method in which polymerization is performed in an organic solvent in the presence of a polymerization initiator.

Examples of the organic solvent that is used during the solution polymerization method include an alcohol-based solvent such as methanol, ethanol, propanol, isopropanol, butanol, octanol, dodecanol, ethylene glycol, and propylene glycol; an ether-based solvent such as tetrahydron; a ketone-based solvent such as acetone, methyl ethyl ketone, and acetylacetone; an ester-based solvent such as methyl acetate, ethyl acetate, butyl acetate, and phenyl acetate; a glycol ether-based solvent such as ethyl cellosolve, butyl cellosolve, ethyl carbitol, butyl carbitol, ethylene glycol monomethyl ether, ethylene glycol monoethyl ether, ethylene glycol monoisopropyl ether, ethylene glycol monobutyl ether, ethylene glycol monohexyl ether, ethylene glycol monophenyl ether, diethylene glycol monomethyl ether, diethylene glycol monoethyl ether, diethylene glycol monobutyl ether, diethylene glycol dimethyl ether, diethylene glycol diethyl ether, triethylene glycol monomethyl ether, triethylene glycol monoethyl ether, triethylene glycol monobutyl ether, propylene glycol monomethyl ether, propylene glycol monoethyl ether, dipropylene glycol monomethyl ether, dipropylene glycol monoethyl ether, and diethylene glycol monomethyl ether acetate; a phenol-based solvent such as phenol and cresol; an aliphatic or aromatic hydrocarbon-based solvent such as pentane, hexane, heptane, octane, dodecane, tridecane, tetradecane, pentadecane, hexadecane, octadecane, octadecene, benzene, toluene, xylene, trimethine, nitrobenzene, aniline, methoxybenzene, and trimethine; and an aliphatic or aromatic chlorinated hydrocarbon-based solvent such as dichloromethane, chloroform, trichloroethane, chlorobenzene, and dichlorobenzene.

Examples of the polymerization initiator that can be used in the copolymerization of the hydroxyl group-containing acrylic resin (z11) include known radical polymerization initiators such as 2,2′-azobisisobutyronitrile, benzoyl peroxide, di-t-butyl peroxide, di-t-amyl peroxide, t-butyl peroctoate, 2,2′-azobis(2-methylbutyronitrile), and 2,2′-azobis(2,4-dimethylvaleronitrile).

The hydroxyl group-containing acrylic resins (z11) may be used alone or in combination of two or more thereof.

### Polyisocyanate Compound (z2)

The polyisocyanate compound (z2) is a compound having at least two isocyanate groups per molecule, and examples thereof include an aliphatic polyisocyanate, an alicyclic polyisocyanate, an aromatic-aliphatic polyisocyanate, an aromatic polyisocyanate, and a derivative of the polyisocyanate.

Examples of the aliphatic polyisocyanates include aliphatic diisocyanates, such as trimethylene diisocyanate, tetramethylene diisocyanate, hexamethylene diisocyanate, pentamethylene diisocyanate, 1,2-propylene diisocyanate, 1,2-butylene diisocyanate, 2,3-butylene diisocyanate, 1,3-butylene diisocyanate, 2,4,4- or 2,2,4-trimethylhexamethylene diisocyanate, dimer acid diisocyanate, and methyl 2,6-diisocyanatohexanoate (common name: lysine diisocyanate); and aliphatic triisocyanates, such as 2-isocyanatoethyl 2,6-diisocyanatohexanoate, 1,6-diisocyanato-3-isocyanatomethylhexane, 1,4,8-triisocyanatooctane, 1,6,11-triisocyanatoundecane, 1,8-diisocyanato-4-isocyanatomethyloctane, 1,3,6-triisocyanatohexane, and 2,5,7-trimethyl-1,8-diisocyanato-5-isocyanatomethyloctane.

Examples of the alicyclic polyisocyanates include alicyclic diisocyanates, such as 1,3-cyclopentene diisocyanate, 1,4-cyclohexane diisocyanate, 1,3-cyclohexane diisocyanate, 3-isocyanatomethyl-3,5,5-trimethylcyclohexyl isocyanate (common name: isophorone diisocyanate), 4-methyl-1,3-cyclohexylene diisocyanate (common name: hydrogenated TDI), 2-methyl-1,3-cyclohexylene diisocyanate, 1,3- or 1,4-bis(isocyanatomethyl)cyclohexane (common name: hydrogenated xylylene diisocyanate) or its mixture, methylenebis(4,1-cyclohexanediyl) diisocyanate (common name: hydrogenated MDI), and norbornane diisocyanate; and alicyclic triisocyanates, such as 1,3,5-triisocyanatocyclohexane, 1,3,5-trimethylisocyanatocyclohexane, 2-(3-isocyanatopropyl)-2,5-di(isocyanatomethyl)-bicyclo(2.2.1)heptane, 2-(3-isocyanatopropyl)-2,6-di(isocyanatomethyl)-bicyclo(2.2.1)heptane, 3-(3-isocyanatopropyl)-2,5-di(isocyanatomethyl)-bicyclo(2.2.1)heptane, 5-(2-isocyanatoethyl)-2-isocyanatomethyl-3-(3-isocyanatopropyl)-bicyclo(2.2.1)heptane, 6-(2-isocyanatoethyl)-2-isocyanatomethyl-3-(3-isocyanatopropyl)-bicyclo(2.2.1)heptane, 5-(2-isocyanatoethyl)-2-isocyanatomethyl-2-(3-isocyanatopropyl)-bicyclo(2.2.1)-heptane, and 6-(2-isocyanatoethyl)-2-isocyanatomethyl-2-(3-isocyanatopropyl)-bicyclo(2.2.1)heptane.

Examples of the aromatic-aliphatic polyisocyanates include aromatic-aliphatic diisocyanates, such as methylenebis(4,1-phenylene) diisocyanate (common name: MDI), 1,3- or 1,4-xylylene diisocyanate or its mixture, ω,ω′-diisocyanato-1,4-diethylbenzene, and 1,3- or 1,4-bis(1-isocyanato-1-methylethyl)benzene (common name: tetramethylxylylene diisocyanate) or its mixture; and aromatic-aliphatic triisocyanates, such as 1,3,5-triisocyanatomethylbenzene.

Examples of the aromatic polyisocyanates include aromatic diisocyanates, such as m-phenylene diisocyanate, p-phenylene diisocyanate, 4,4′-diphenyl diisocyanate, 1,5-naphthalene diisocyanate, 2,4-tolylene diisocyanate (common name: 2,4-TDI) or 2,6-tolylene diisocyanate (common name: 2,6-TDI) or its mixture, 4,4′-toluidine diisocyanate, and 4,4′-diphenyl ether diisocyanate; aromatic triisocyanates, such as triphenylmethane-4,4′,4″-triisocyanate, 1,3,5-triisocyanatobenzene, and 2,4,6-triisocyanatotoluene; and aromatic tetraisocyanates, such as 4,4′-diphenylmethane-2,2′,5,5′-tetraisocyanate.

In addition, examples of the derivatives of the polyisocyanates include dimers, trimers, biuret, allophanate, uretdione, uretoimine, isocyanurates, oxadiazinetrione, and polymethylene polyphenyl polyisocyanates (crude MDI and polymeric MDI), and crude TDI of the polyisocyanates described above.

The polyisocyanates and their derivatives may be used alone or in combination of two or more types.

Examples that can be suitably used include hexamethylene diisocyanate-based compounds among the aliphatic diisocyanates and 4,4′-methylenebis(cyclohexyl isocyanate) among the alicyclic diisocyanates. Among these, a derivative of hexamethylene diisocyanate is optimal from the viewpoint of adherence and compatibility.

In addition, examples of the polyisocyanate compound (z2) that may be used include prepolymers formed by reacting the polyisocyanate or its derivative described above with a compound having an active hydrogen group, such as a hydroxyl group or an amino group, which can react with the polyisocyanate, under conditions of excess isocyanate groups. Examples of the compound that can react with the polyisocyanate include polyhydric alcohols, low molecular weight polyester resins, amines, and water.

In addition, examples of the polyisocyanate compound (z2) also include blocked polyisocyanate compounds, which are compounds formed by blocking an isocyanate group in the polyisocyanate and its derivative with a blocking agent.

Examples of the blocking agent include phenolic compounds, such as phenol, cresol, xylenol, nitrophenol, ethylphenol, hydroxydiphenyl, butylphenol, isopropylphenol, nonylphenol, octylphenol, and methyl hydroxybenzoate; lactam-based compounds, such as F-caprolactam, 6-valerolactam, γ-butyrolactam, and β-propiolactam; aliphatic alcohol-based compounds, such as methanol, ethanol, propyl alcohol, butyl alcohol, amyl alcohol, and lauryl alcohol; ether-based compounds, such as ethylene glycol monomethyl ether, ethylene glycol monoethyl ether, ethylene glycol monobutyl ether, diethylene glycol monomethyl ether, diethylene glycol monoethyl ether, propylene glycol monomethyl ether, and methoxymethanol; alcohol-based compounds, such as benzyl alcohol, glycolic acid, methyl glycolate, ethyl glycolate, butyl glycolate, lactic acid, methyl lactate, ethyl lactate, butyl lactate, methylol urea, methylol melamine, diacetone alcohol, 2-hydroxyethyl acrylate, and 2-hydroxyethyl methacrylate; oxime-based compounds, such as formamide oxime, acetoamide oxime, acetoxime, methyl ethyl ketoxime, diacetyl monoxime, benzophenone oxime, and cyclohexane oxime; active methylene-based compounds, such as dimethyl malonate, diethyl malonate, ethyl acetoacetate, methyl acetoacetate, and acetylacetone; mercaptan-based compounds, such as butyl mercaptan, t-butyl mercaptan, hexyl mercaptan, t-dodecyl mercaptan, 2-mercaptobenzothiazole, thiophenol, methylthiophenol, and ethylthiophenol; acid amide-based compounds, such as acetanilide, acetanisidide, acetotoluide, acrylamide, methacrylamide, acetic amide, stearic amide, and benzamide; imide-based compounds, such as succinimide, phthalimide, and maleimide; amine-based compounds, such as diphenylamine, phenylnaphthylamine, xylidine, N-phenylxylidine, carbazole, aniline, naphthylamine, butylamine, dibutylamine, and butylphenylamine; imidazole-based compounds, such as imidazole and 2-ethylimidazole; urea-based compounds, such as urea, thiourea, ethyleneurea, ethylenethiourea, and diphenylurea; carbamic ester-based compounds, such as phenyl N-phenylcarbamate; imine-based compounds, such as ethyleneimine and propyleneimine; sulfite-based compounds, such as sodium bisulfite and potassium bisulfite; and azole-based compounds. Examples of the azole-based compounds include pyrazole or pyrazole derivatives, such as pyrazole, 3,5-dimethylpyrazole, 3-methylpyrazole, 4-benzyl-3,5-dimethylpyrazole, 4-nitro-3,5-dimethylpyrazole, 4-bromo-3,5-dimethylpyrazole, and 3-methyl-5-phenylpyrazole; imidazole or imidazole derivatives, such as imidazole, benzimidazole, 2-methylimidazole, 2-ethylimidazole, and 2-phenylimidazole; and imidazoline derivatives, such as 2-methylimidazoline and 2-phenylimidazoline.

When an isocyanate group of the polyisocyanate compound is blocked (the polyisocyanate compound is reacted with a blocking agent), a solvent can be added as necessary.

The polyisocyanate compound (z2) can be used alone or in combination of two or more.

The equivalent ratio (NCO/OH) of the isocyanate group in the polyisocyanate compound (z2) to the hydroxyl group in the hydroxyl group-containing resin (z1) in the clear coating composition (Z) is preferably in a range from 0.5 to 2.0, and more preferably in a range from 0.8 to 1.5.

The clear coating composition (Z) can appropriately contain as necessary a solvent, such as water or an organic solvent; or an additive for a coating material, such as a curing catalyst, a defoamer, an ultraviolet absorber, a rheology control agent, and an antisettling agent.

The clear coating composition (Z) can appropriately contain a coloring pigment in a range that does not impair the transparency of the coating film. As the coloring pigment, a pigment known for an ink or for a coating material can be used alone, or two or more types of such pigments can be used in combination. The blended amount thereof differs based on the type and the like of the coloring pigment to be used, and the blended amount is usually 30 mass % or less, preferably in a range from 0.05 to 20 mass %, and more preferably in a range from 0.1 to 10 mass %, with respect to the total amount of the solid content of the resin component of the clear coating composition (Z).

The clear coating composition (Z) can be applied by a method such as electrostatic coating, air spraying, or airless spraying, and the film thickness of the clear coating film is, based on the cured coating film, approximately from 10 to 60 m, more preferably from 15 to 50 m, and even more preferably approximately from 20 to 40 m.

The solid content percentage of the clear coating composition (Z) is in a range from 10 to 65 mass %, more preferably in a range from 15 to 55 mass %, and even more preferably in a range from 20 to 50 mass %. Furthermore, the viscosity of the clear coating composition (Z) is appropriately adjusted to a range suitable for application using water and/or an organic solvent such that at 20° C., the viscosity determined using a Ford viscosity cup No. 4 is typically preferably in an approximate range from 15 to 60 seconds, and particularly preferably in an approximate range from 20 to 50 seconds.

### Step (3)

According to the multilayer coating film forming method of an embodiment of the present disclosure, subsequently, the effect coating film formed in (1) above and the clear coating film formed in (2) above are heated separately or simultaneously and cured.

The heating can be implemented, for example, by a means such as hot air heating, infrared heating, and high frequency heating. The heating temperature is preferably from 80 to 160° C. and more preferably from 100 to 140° C. Furthermore, the heating time is preferably from 10 to 60 minutes, and more preferably from 15 to 40 minutes. Before performing the above heating and curing, heating may be performed as necessary directly or indirectly by preheating, air blowing, or the like at a temperature of about 50 to about 110° C. and preferably of about 60 to about 90° C. approximately for 1 to 60 minutes.

### EXAMPLES

The present invention will be described more specifically below with reference to examples and comparative examples. However, the present invention is not limited to these examples only. Both “parts” and “%” are based on mass.

### [1] Preparation of Substrate

### Object 1 to be Coated

A cationic electrodeposition coating material “Electron GT-10” (trade name, available from Kansai Paint Co., Ltd., a coating material in which a block polyisocyanate compound is used as a curing agent in an epoxy resin polyamine-based cation resin) was applied by electrodeposition on a degreased and zinc phosphate-treated steel sheet (JIS G 3141, a size of 400 mm×300 mm×0.8 mm) to give a film thickness of a cured coating film of 20 m. The coating material was cross-linked and cured by heating at 170° C. for 20 minutes, and an electrodeposition coating film was formed.

On the electrodeposition coating surface of the resulting steel sheet, “TP-65-2” (trade name, available from Kansai Paint Co., Ltd.; polyester resin and amino resin-based organic solvent-type intermediate coating composition) was electrostatically applied by using a rotary electrostatic coater to give a cured film thickness of 35 m, and cured by heating at 140° C. for 30 minutes, and thereby an intermediate coating film was formed for use as an object 1 to be coated.

### Object 2 to be Coated

On an OHP sheet, “TP-65-2” (trade name, available from Kansai Paint Co., Ltd.; polyester resin and amino resin-based organic solvent-type intermediate coating composition) was electrostatically applied using a rotary electrostatic coater to give a cured film thickness of m, and was cured by heating at 140° C. for 30 minutes, and thereby an intermediate coating film was formed for use as an object 2 to be coated.

### [2] Production of Coating Material

### Production of Viscosity Modifier (D)

### Production Example 1

A monomer mixture composed of 20 parts of methacrylic acid, 19.5 parts of an acrylate of a 60 mol adduct of n-octadecyl alcohol ethylene oxide, 60 parts of propyl acrylate, and 0.5 parts of a diacrylate of a 15 mol adduct of ethylene glycol ethylene oxide, and 50 parts of a 1% methyl triglycol solution of 2,2′-azobisisobutyronitrile were each added dropwise from a dropping funnel to 350 parts of methyl triglycol at a constant rate over 1.5 hours with uniform stirring, and the materials were reacted. The reaction temperature was maintained at a temperature from 80 to 90° C. After completion of the dropwise addition, the mixture was maintained at the same temperature for 3 hours and then cooled to 40° C., resulting in the formation of a viscosity modifier (D-1), which was a diluted solution of an acrylic associative thickener having a solid content of 20%.

### Production Example 2

A reaction vessel equipped with a thermometer, a thermostat, a stirring device, a reflux condenser, a nitrogen gas inlet tube, and two dripping devices was charged with 15.4 parts (10 parts in terms of solid content) of a below-described macromonomer solution, 20 parts of ethylene glycol monobutyl ether, and 30 parts of diethylene glycol monoethyl ether acetate, and the temperature was raised to 85° C. while nitrogen gas was introduced into the liquid. Next, with the reaction vessel maintained at the same temperature, a mixed solution consisting of 31.5 parts of N,N-dimethylacrylamide, 31.5 parts of N-isopropyl acrylamide, 27 parts of 2-hydroxyethyl acrylate, 10 parts of ethylene glycol monobutyl ether, and 40 parts of diethylene glycol monoethyl ether acetate, and a mixed solution consisting of 0.15 parts of “Perbutyl O” (trade name, available from NOF Corporation, polymerization initiator, tert-butylperoxy-2-ethylhexanoate) and 20 parts of ethylene glycol monobutyl ether were simultaneously added dropwise into the reaction vessel over 4 hours, and after dropwise addition was completed, the mixture was stirred and aged for 2 hours at the same temperature. Next, with the reaction vessel maintained at the same temperature, a mixed solution consisting of 0.3 parts of 2,2′-azobis (2,4-dimethylvaleronitrile) and 15 parts of ethylene glycol monobutyl ether was added dropwise over one hour into the reaction vessel, and after dropwise addition was completed, the mixture was stirred and aged at the same temperature for 1 hour. Next, the mixture was cooled to ° C. while ethylene glycol monobutyl ether was added, resulting in the formation of a copolymer solution having a solid content of 35%. The weight average molecular weight of the resulting copolymer was 310000. An amount of 215 parts of deionized water was added to the resulting copolymer solution, resulting in the formation of a viscosity modifier (D-2), which was a diluted solution of an acrylic associative thickener having a solid content of 20%.

Macromonomer solution: A reaction vessel equipped with a thermometer, a thermostat, a stirring device, a reflux condenser, a nitrogen gas inlet tube, and a dripping device was charged with 16 parts of ethylene glycol monobutyl ether and 3.5 parts of 2,4-diphenyl-4-methyl-1-pentene, nitrogen gas was then introduced into the gas phase, and the temperature was increased to 160° C. while stirring. Once the temperature reached 160° C., a mixed solution consisting of 30 parts of n-butyl methacrylate, 40 parts of 2-ethylhexyl methacrylate, 30 parts of 2-hydroxyethyl methacrylate, and 7 parts of di-tert-amyl peroxide was added dropwise over 3 hours, after which the mixed solution was stirred at the same temperature for 2 hours. The mixture was then cooled to 30° C. and diluted with ethylene glycol monobutyl ether, resulting in the formation of a macromonomer solution having a solid content of 65%. The hydroxyl value of the resulting macromonomer was 125 mg KOH/g, and the number average molecular weight was 2300.

### Production of Effect Coating Composition

### Example 1

A stirring and mixing container was charged with 100 parts (solid content: 20 parts) of “LeafPowder 49CJ-1120” (trade name, available from Oike & Co., Ltd.; indium particles; solid content: 20%; dispersed in propylene glycol monomethyl ether), 1.8 parts (solid content: 1.8 parts) of “BYK-348” (trade name, available from BYK-Chemie GmbH; silicone-based surface conditioner; solid content: 100%), 1.8 parts (solid content: 1.8 parts) of “Plysurf A208F” (trade name, available from DKS Co., Ltd., polyoxyethylene alkyl (C8) ether phosphate, aqueous solution of 99% solid content), 9 parts (solid content: 1.8 parts) of the viscosity modifier (D-1) produced in Production Example 1, 51.9 parts of a 1% dimethylethanolamine aqueous solution, and 340 parts of distilled water, and the materials were mixed with stirring to produce an effect coating composition (Y-1) having a solid content percentage of 5.0 mass %.

### Examples 2 to 7 and Comparative Examples 1 to 5

Effect coating compositions (Y-2) to (Y-12) were each produced in the same manner as in Example 1 with the exception of employing the formulations and solid content percentages described in Table 1.

TABLE 1
Numerical values in parentheses ( ) indicate solid content.

| | | | Examples | | | | | | |
|---|---|---|---|---|---|---|---|---|---|
| Example No. | | | 1 | 2 | 3 | 4 | 5 | 6 | 7 |
| Name of effect coating composition | | | Y-1 | Y-2 | Y-3 | Y-4 | Y-5 | Y-6 | Y-7 |
| Formulation | Indium particle (A) | “LeafPowder | 100 (20) | 100 (20) | 100 (20) | 100 (20) | 100 (20) | 100 (20) | 100 (20) |
| | | 49CJ-1120” | | | | | | | |
| | Effect pigment | “Hydroshine WS- | | | | | | | |
| | other than indium | 3001” (*1) | | | | | | | |
| | particles (A) | | | | | | | | |
| | Surface conditioner | “BYK-348” | 1.8 (1.8) | 1.8 (1.8) | 1.8 (1.8) | 1.8 (1.8) | | 1.8 (1.8) | 1.8 (1.8) |
| | (B) | “BYK-381” (*2) | | | | | 3.4 (1.8) | | |
| | Pigment dispersant | “Plysurf A208F” | 1.8 (1.8) | 1.8 (1.8) | 1.8 (1.8) | 1.8 (1.8) | 1.8 (1.8) | | 1.8 (1.8) |
| | (C) | “BYK-190” | | | | | | 4.5 (1.8) | |
| | Viscosity modifier | Viscosity modifier | 9 (1.8) | 9 (1.8) | 9 (1.8) | 9 (1.8) | 9 (1.8) | 9 (1.8) | |
| | (D) | (D-1) | | | | | | | |
| | | Viscosity modifier | | | | | | | 9 (1.8) |
| | | (D-2) | | | | | | | |
| | 1% Dimethylethanolamine aqueous solution | | 51.9 | 51.9 | 51.9 | 51.9 | 51.9 | | 51.9 |
| | Water (E) | Distilled water | 340 | 1100 | 153 | 47 | 340 | 392 | 340 |

| | | | | | | | |
|---|---|---|---|---|---|---|---|
| Solid content (mass %) | 5.0 | 2.0 | 8.0 | 12.0 | 5.0 | 5.0 | 5.0 |

Numerical values in parentheses indicate solid content.

| | | | Comparative Example | | | | |
|---|---|---|---|---|---|---|---|
| Example No. | | | 1 | 2 | 3 | 4 | 5 |
| Name of effect coating composition | | | Y-8 | Y-9 | Y-10 | Y-11 | Y-12 |
| Formulation | Indium particle (A) | “LeafPowder | | 100 (20) | 100 (20) | 100 (20) | 100 (20) |
| | | 49CJ-1120” | | | | | |
| | Effect pigment | “Hydroshine WS- | 200 (20) | | | | |
| | other than indium | 3001” (*1) | | | | | |
| | particles (A) | | | | | | |
| | Surface conditioner | “BYK-348” | 1.8 (1.8) | | 2.7 (2.7) | 2.7 (2.7) | 1.8 (1.8) |
| | (B) | “BYK-381” (*2) | | | | | |
| | Pigment dispersant | “Plysurf A208F” | 1.8 (1.8) | 2.7 (2.7) | | 2.7 (2.7) | 1.8 (1.8) |
| | (C) | “BYK-190” | | | | | |
| | Viscosity modifier | Viscosity modifier (D-1) | 9 (1.8) | 13.5 (2.7) | 13.5 (2.7) | | 9 (1.8) |
| | (D) | Viscosity modifier (D-2) | | | | | |
| | 1% Dimethylethanolamine aqueous solution | | 51.9 | 51.9 | 51.9 | 51.9 | 46.0 |
| | Water (E) | Distilled water | 240 | 340 | 340 | 348 | |

| | | | | | |
|---|---|---|---|---|---|
| Solid content (mass %) | 5.0 | 5.0 | 5.0 | 5.0 | 16.0 |

(*1) “Hydroshine WS-3001”: water-based vapor-deposited aluminum flake pigment, available from Eckart GmbH, solid content: 10%, internal solvent: isopropanol, average particle size D50: 13 μm, thickness: 0.05 μm.
(*2) “BYK-381”: trade name, available from BYK-Chemie GmbH, acrylic-based surface conditioner, solid content 52%, internal solvent: dipropylene glycol monomethyl ether.

### Preparation of Clear Coating Composition (Z′)

### Clear Coating Composition (Z-1)

“KINO-6510” (trade name, Kansai Paint Co., Ltd.; hydroxyl group/isocyanate group-curable acrylic resin-urethane resin-based two-component organic solvent-type coating material containing a hydroxyl group-containing resin and a polyisocyanate compound) was used as a clear coating composition (Z-1).

### [3] Preparation of Test Sheets

### Example 8

### Preparation of Test Sheet for Measuring Specular Gloss (600 Gloss)

The effect coating composition (Y-1) produced in [2] above was stirred for 1 minute using the ultrasonic disperser “UH-50” (trade name, available from MST KK).

Next, using a minibell rotary electrostatic coater at a booth temperature of 23° C. and humidity of 68%, the effect coating composition (Y-1) was applied onto the object 1 to be coated, which was prepared in [1] above, at an amount for obtaining a film thickness as a cured coating film of 0.05 m, the coated object 1 was allowed to stand for 3 minutes at room temperature and then pre-heated at 80° C. for 3 minutes, resulting in the formation of an uncured effect coating film.

Subsequently, using a minibell rotary electrostatic coater at a booth temperature of 23° C. and humidity of 68%, the clear coating composition (Z-1) prepared in [2] above was applied onto the uncured effect coating film at such an amount that a film thickness as a cured coating film of 35 m was provided, the coated uncured effect coating film was then allowed to stand for 7 minutes at room temperature, and then heated, dried, and cured in a hot air circulation type drying furnace at 140° C. for 30 minutes, and a test sheet for measuring the specular gloss (60° gloss) of Example 7 was thereby prepared.

Here, the dry coating film thickness of the effect coating film was calculated from the following equation. The same applies to the following examples.

$$x = sc / sg / S * 10000$$

x: Film thickness [μm]
sc: Solid content [g] coated by application
sg: Specific gravity of coating film [g/cm³]
S: Evaluated surface area [cm²] of the solid content coated by application

### Preparation of Test Sheet for Measuring Millimeter Wave Transmittance

A test sheet for measuring millimeter wave transmittance was prepared in the same manner as described in the “Preparation of Test Sheet for Measuring Specular Gloss (60° Gloss)” section except that the object 2 to be coated was used in place of the object 1 to be coated, which was used in the “Preparation of Test Sheet for Measuring Specular Gloss (60° Gloss)”.

### Examples 9 to 19 and Comparative Examples 6 to 10

Test sheets were each produced in the same manner as in Example 8 with the exception of using the coating materials, heating temperatures, and heating times described in Table 2.

### Coating Film Evaluation

The coating film was evaluated by the following methods for each test sheet produced as described above, and the results are shown in Table 2.

### Specular Gloss (60° Gloss)

A 60° gloss value was measured using a gloss meter (micro-TRI-gloss, available from BYK-Gardner GmbH). A larger value indicates more superior glossiness. A value of 130 or greater is considered to be passing.

### Millimeter Wave Transmittance

At room temperature, electromagnetic waves of frequencies of 60 to 90 GHz were made incident at an incident angle of 0° on the coating film from a transmitter using a “vector network analyzer” (ME7838A, available from Anritsu Corporation), the “attenuation factor when only an OHP sheet was installed” and the “attenuation factor when the test sheet for measuring millimeter wave transmittance was installed” were each measured, and the attenuation factor at 76 GHz was determined from the following Equation 1.

$$Attenuation factor ( dB ) = ( attenuation factor when only an OHP sheet was installed ) - ( attenuation factor when a test sheet for measuring millimeter wave transmittance was installed ) \qquad Equation 1$$

From the resulting attenuation factor, the millimeter wave transmittance at 76 GHz was determined by the following Equation 2.

$$Millimeter wave transmittance ( \% ) = {10}^{- [ ( attenuation factor ) / 20 \}} \times 100 \qquad Equation 2$$

TABLE 2

| | Examples | | | | | | | | | | | |
|---|---|---|---|---|---|---|---|---|---|---|---|---|
| | 8 | 9 | 10 | 11 | 12 | 13 | 14 | 15 | 16 | 17 | 18 | 19 |
| Name of effect coating | Y-1 | Y-1 | Y-1 | Y-1 | Y-1 | Y-1 | Y-2 | Y-3 | Y-4 | Y-5 | Y-6 | Y-7 |
| composition (Y) | | | | | | | | | | | | |
| Film thickness (μm) of | 0.05 | 0.10 | 0.20 | 0.50 | 0.90 | 0.20 | 0.20 | 0.20 | 0.20 | 0.20 | 0.20 | 0.20 |
| effect coating film | | | | | | | | | | | | |
| Heating temperature/time | 80° C./ | 80° C./ | 80° C./ | 80° C./ | 80° C./ | 140° C./ | 80° C./ | 80° C./ | 80° C./ | 80° C./ | 80° C./ | 80° C./ |
| of effect coating film | 3 min. | 3 min. | 3 min. | 3 min. | 3 min. | 30 min. | 3 min. | 3 min. | 3 min. | 3 min. | 3 min. | 3 min. |
| Name of clear coating | Z-1 | Z-1 | Z-1 | Z-1 | Z-1 | Z-1 | Z-1 | Z-1 | Z-1 | Z-1 | Z-1 | Z-1 |
| composition (Z) | | | | | | | | | | | | |
| Specular gloss (60° gloss) | 150 | 165 | 160 | 155 | 140 | 160 | 161 | 155 | 152 | 150 | 148 | 153 |
| Millimeter wave | 96 | 95 | 95 | 94 | 92 | 95 | 95 | 94 | 94 | 95 | 95 | 95 |
| transmittance (%) at 76 | | | | | | | | | | | | |
| GHz | | | | | | | | | | | | |

| | Comparative Example | | | | |
|---|---|---|---|---|---|
| | 6 | 7 | 8 | 9 | 10 |
| Name of effect coating | Y-8 | Y-9 | Y-10 | Y-11 | Y-12 |
| composition (Y) | | | | | |
| Film thickness (μm) of | 0.20 | 0.20 | 0.20 | 0.20 | 0.20 |
| effect coating film | | | | | |
| Heating temperature/time | 80° C./ | 80° C./ | 80° C./ | 80° C./ | 80° C./ |
| of effect coating film | 3 min. | 3 min. | 3 min. | 3 min. | 3 min. |
| Name of clear coating | Z-1 | Z-1 | Z-1 | Z-1 | Z-1 |
| composition (Z) | | | | | |
| Specular gloss (60° gloss) | 110 | 105 | 100 | 96 | 120 |
| Millimeter wave | 18 | 95 | 96 | 96 | 94 |
| transmittance (%) at 76 | | | | | |
| GHz | | | | | |

Although embodiments and examples of the present invention have been specifically described above, the present invention is not limited to the embodiments described above, and various modifications based on the technical idea of the present invention are possible.

For example, the configurations, methods, processes, shapes, materials, numerical values, etc., given in the above-described embodiments and examples are merely examples, and different configurations, methods, processes, shapes, materials, numerical values, etc., may be used when necessary.

Also, the configurations, methods, processes, shapes, materials, numerical values, etc. of the above-described embodiments can be combined with each other without departing from the gist of the present invention.

1. An effect coating composition comprising indium particles (A), a surface conditioner (B), a pigment dispersant (C), a viscosity modifier (D), and water (E),
the effect coating composition having a solid content percentage of from 0.1 to 15 mass %.

2. The effect coating composition according to claim 1, wherein the surface conditioner (B) comprises a silicone-based surface conditioner.

3. The effect coating composition according to claim 1, wherein the pigment dispersant (C) comprises a phosphate group-containing compound.

4. The effect coating composition according to claim 1, wherein the viscosity modifier (D) comprises an associative viscosity modifier.

5. The effect coating composition according to claim 1, wherein a content of the water (E) is in a range from 50 to 95 parts by mass per 100 parts by mass of a total of all components of the effect coating composition.

6. The effect coating composition according to claim 1, wherein the surface conditioner (B) comprises a silicone-based surface conditioner and a content of the water (E) is in a range from 50 to 95 parts by mass per 100 parts by mass of a total of all components of the effect coating composition.

7. The effect coating composition according to claim 1, wherein the pigment dispersant (C) comprises a phosphate group-containing compound and a content of the water (E) is in a range from 50 to 95 parts by mass per 100 parts by mass of a total of all components of the effect coating composition.

8. The effect coating composition according to claim 1, wherein the viscosity modifier (D) comprises an associative viscosity modifier and a content of the water (E) is in a range from 50 to 95 parts by mass per 100 parts by mass of a total of all components of the effect coating composition.

9. A method for forming a multilayer coating film, the method comprising:
(1) applying the effect coating composition described in claim 1 onto an object to be coated to form an effect coating film;
(2) applying a clear coating composition (Z) onto the effect coating film produced in (1) to form a clear coating film; and
(3) heating, separately or simultaneously, the effect coating film formed in (1) and the clear coating film formed in (2) to thereby cure the effect coating film and the clear coating film.

10. The method according to claim 9, wherein the surface conditioner (B) comprises a silicone-based surface conditioner.

11. The method according to claim 9, wherein the pigment dispersant (C) comprises a phosphate group-containing compound.

12. The method according to claim 9, wherein the viscosity modifier (D) comprises an associative viscosity modifier.

13. The method according to claim 1, wherein a content of the water (E) is in a range from 50 to 95 parts by mass per 100 parts by mass of a total of all components of the effect coating composition.
